(19) United States
(12) Patent Application Publication
(10) Pub. No.: US 2009/0327466 A1
(43) Pub. Date: Dec. 31, 2009

(54) INTERNAL UNIFORM RESOURCE LOCATOR FORMULATION AND TESTING

(75) Inventors: Daniel Vasquez Lopez, Redmond, WA (US); Carlos Aquilar Mares, Snoqualmie, WA (US); Crystal L. Hoyer, Seattle, WA (US); Rusian Yakushev, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/163,852

(22) Filed: Jun. 27, 2008

(51) Int. Cl. G06F 15/16

(52) U.S. Cl. 709/223

(57) ABSTRACT

A mechanism for computer-assisted generation of matching rules for a proposed internal Uniform Resource Locator (URL) to a corresponding possible public URL. After accessing the proposed internal URL from the user, one or more options for a public URL corresponding to the internal URL are generated. Also, a mechanism for testing whether a candidate public Uniform Resource Locator (URL) has a corresponding match to an internal URL. Upon accessing a candidate public URL, matching rules are used to determine whether or not the candidate public URL matches a valid internal URL using any of the matching rules. If it is determined that there is not a match, matching rules that may be used to more closely match the candidate public URL to the valid internal URL are then displayed.

### BACKGROUND

A Uniform Resource Locator or URL is used to identify and access a resource over a network. A URI typically might begin with a prefix identifier such as <http://> which identifies the protocol that will be used to obtain the resource. A domain name (e.g., www.example.com) may then be specified that references the network location where the resource may be found. For example, www.example.com may be used to find the corresponding Internet Protocol (IP) address where the resource resides. The remainder of the URL (called hereinafter a server resource identifier) identifies the resource to the server that hosts the resource. The server resource identifier may include a path name and a file name. In addition, if the resource is an executable file, the local resource identifier may also include a query string that provides one or more input parameters to the executable file, whereupon the result of the execution is returned to the requester.

For example, the following URL includes query string parameters: hxxp://wyw.example.com/default.aspx?tabid=2. In this patent application, the usual prefix identifier “http://” has been replaced by “hxxp”, in order to avoid the automated hyperlinking of the printed form of this document. The portion “wyw.example.com” is the domain name. The “www” term has been replaced by the term “wyw” throughout this patent application for the same reason. The terms “default.aspx?tabid=2” is the server resource identifier that includes the query string “?tabid=2”.

This internal URL representation is fine for internal processing of the URL by the server. However, the internal URL representation has several problems in that it is not easy to use in verbal communication. Also, the URL does not present itself to a search engine in a manner that the search engine can discover information about the resources content. This is because when search engines crawl through various URLs to categorize the URLs, the search engines tend to ignore the information in the query string to the right of the question mark “?”.

To address these problems, there have been a number of conventional technologies which provide a different more user-friendly public URL. For instance, hxxp://wyw.example.com/default.aspx?tabid=2 may instead be publicly presented as hxxp://wyw.example.com/team/about. A special rewrite component at the server takes care of translating all or portions of the public URL into the internal URL for processing by the server. Thus, the internal URL can be used by the server, while allowing users a more intuitive view of a public URL that may also be more effectively categorized by search engines.

### BRIEF SUMMARY

Embodiments described herein provide a mechanism for computer-assisted generation of matching rules for a proposed internal Uniform Resource Locator (URL) to a corresponding possible public URL. After accessing the proposed internal URL from the user, one or more options for a public URL corresponding to the internal URL are generated. In one embodiment, the user may then select one of the options for the public URL, whereupon the corresponding matching rules are generated. Accordingly, matching rules may be quite conveniently generated.

In another embodiment, a mechanism for testing whether a candidate public Uniform Resource Locator (URL) has a corresponding match to an internal URL is provided. Upon accessing a candidate public URL, matching rules are used to determine whether or not the candidate public URL matches a valid internal URL using any of the matching rules. If it is determined that there is not a match, matching rules that may be used to more closely match the candidate public URL to the valid internal URL are then displayed. Perhaps the portion of the matching rules that has preventing a perfect match may be visually distinguished in some way. Thus, a candidate public URI may be tested to verify whether the matching rules are sufficient, thereby allowing possible further editing of the matching rules to more closely conform with the desired public URI(s).

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a flowchart of a method for generating matching rules for a proposed public Uniform Resource Locator (URL) to a corresponding user-selected proposed internal URL;

FIG. 3 illustrates root user interface that includes a main window and an actions window;

FIG. 4 illustrates an early state of a rules generation user interface showing a content of an options drop down menu that shows possible public URLs corresponding to a particular internal URL;

FIG. 5 illustrates a next state of the rules generation user interface in which options drop down menu is scrolled up revealing matching rules for a selected public URL option;

FIG. 6 illustrates the rules generation user interface with a backreference table exposed;

FIG. 7 illustrates a flowchart of a method for testing whether a candidate public URL has a corresponding match to an internal URL;

FIG. 8 illustrates an early state of a rules testing user interface showing that a proposed public URL is being tested against the matching rules to verify whether or not there is a matching internal URL using those matching rules;

FIG. 9 illustrates the rules testing user interface of FIG. 8, except with a backreference table exposed showing matching rules that either match or closely match the public URL to an internal URL; and

FIG. 10 illustrates the rules testing user interface of FIG. 9, except with the matching rules corrected to allow a match between the public URL and the internal URL.

### DETAILED DESCRIPTION

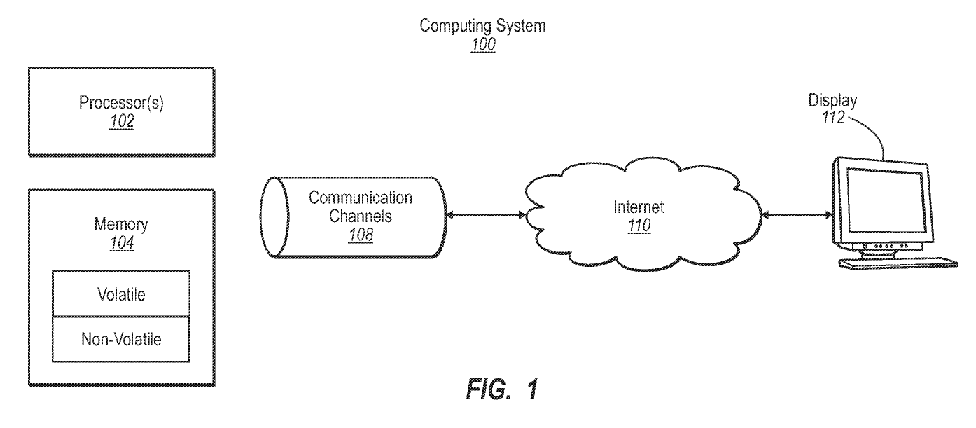

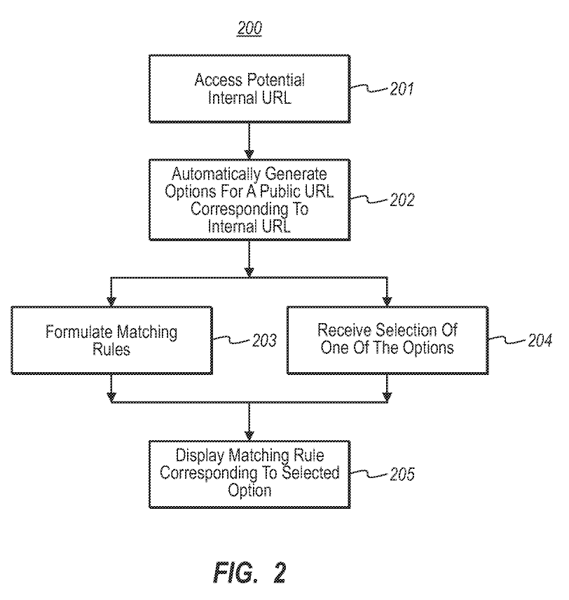

In accordance with embodiments described herein, a mechanism is described for computer-assisted generation of matching rules for a proposed internal Uniform Resource Locator (URL) to a corresponding public internal URL. After accessing the proposed internal URL from the user, one or more options for a public URL corresponding to the internal URL are generated. Also, a mechanism is described for testing whether a candidate public URL has a corresponding match to an internal URL. First, some introductory discussion regarding a computing system in which the principles described herein may be employed will be described with respect to FIG. 1. Then, various embodiments of the matching and testing mechanisms will be described with respect to FIGS. 2 through 10

FIG. 1 illustrates a computing system, which may implement a message processor in software. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

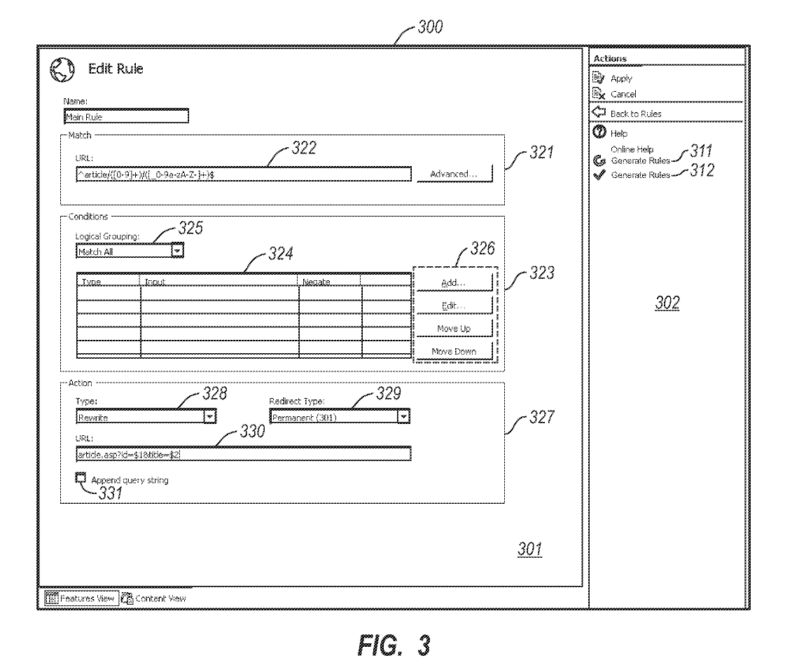

FIG. 2 illustrates a flowchart of a method 200 for generating matching rules for a proposed public Uniform Resource Locator (URL) to a corresponding user-selected proposed internal URL. The method 200 may be accomplished by providing a user interface to a user to allow the user to direct the process. FIG. 3 illustrates an example user interface 300 that might be used to accomplish this. That said, there is a countless variety of user interfaces that may be used consistent with the broader principles described herein.

FIG. 3 illustrates root user interface 300 that includes a main window 301 and an actions window 302. The main window 301 includes a match portion 321 that includes a public URL field 322 that includes the public URL that the matching rules apply to. A condition portion 323 includes a condition list field 324 that contains a list of zero or more additional conditions, and a logical grouping field 325 that indicates whether the conditions should all be met, or whether some minimum number of the conditions should be met in order for the corresponding action to occur. The condition portion 323 also includes controls 326 that allow for appropriate editing of the conditions.

An action portion 327 of the main window 301 includes an action type field 328 that specifies an action to take if the public URL portion in the public URL field matches an incoming URL, and if the conditions specified in the condition list field 324 are met. In the case of the principles described herein, the action is a rewrite of the public URL specified in field 322 to the internal URL specified in 330. Redirect type field 329 is not relevant for purposes of this description. The action type field 328 represents just one of enumerable examples of a mechanism for selecting an action to take when matching the selected public URL to the internal URL.

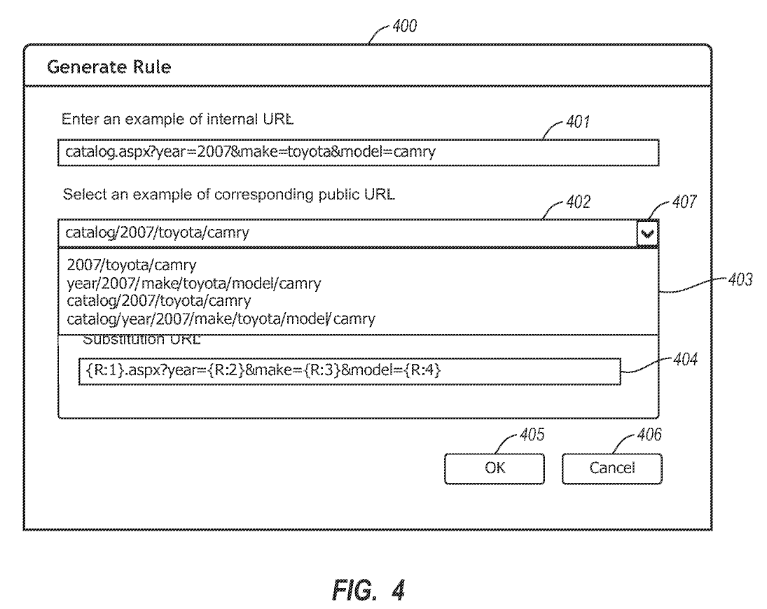

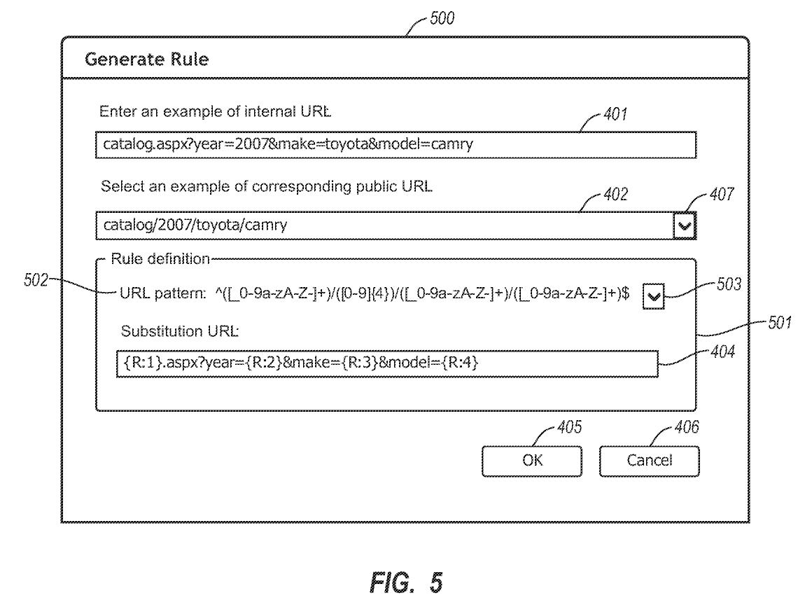

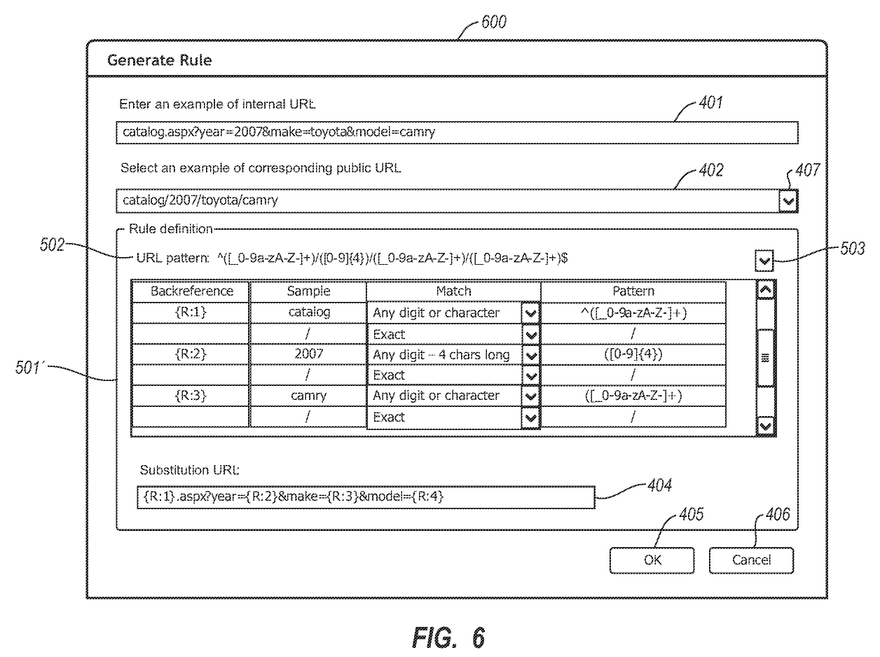

The actions window 302 includes a number of actions that may be performed. Two of these actions are to generate rules by selecting the “Generate Rules” control 311, and to test rewrite rules by selecting the “Test Rewrite Rules” control 312. The method 200 for generating matching rules for a public URL to an internal URL may be initiated upon selecting the “Generate Rules” control 311, whereupon a rules generation user interface of FIG. 4 through 6 may appear. An early state of the rules generation user interface is illustrated in FIG. 4, whereas FIGS. 5 and 6 show successive states of the rules generation user interface.

Returning to FIG. 2, all of the acts may be performed using this or any other suitable rules generation user interface. An internal URL is accessed (act 201). As previously mentioned, the internal URL is used internally to the system, and may sometimes or more often be less intuitive to a human user. Furthermore, internal URLs may also not be readily amenable to a search engine properly categorizing the URL. The internal URL may perhaps only be a portion of a full URL. For instance, the internal URL might perhaps just be a query string, or perhaps a portion of the URL after the domain name. In one embodiment, the method 200 may be performed by the computing system 100 of FIG. 1, in which case, the various user interfaces described and illustrated herein may be displayed on a corresponding display 112.

The internal URL may be entered by a user, or may perhaps just be a proposed internal URL. On the other hand, the internal URL may also be obtained automatically from a data source that includes one or more internal URLs that are used by the computing system. In the user interface 400, the internal URL may be entered into the internal URL field 401. In this example, the internal URL does not include the domain name, but instead only includes an identification of the target file (e.g., catalog.aspx) as well as a corresponding query string “?year=2007&make=toyota&model=camry”.

The computing system automatically generates options for a public URL corresponding to the internal URL (act 202). The logical flow for generating each of the options may perhaps differ somewhat. For instance, in FIG. 4, a drop down list 403 illustrates four options. Each of the options removes the question mark “?”. In this way, search engines may more easily parse the entire public URL, and thus properly and in a more detailed way categorize the URL. The result is that the public URL will be offered when the search query is related to the URL content.

In this example, the public URL represents a series of values taken from the internal URL, and separated by a forward slash “/”. In the first option presented in the drop down list 403, each of the query parameter values of the internal URL (i.e., 2007, toyota, camry) are selected in order from the beginning to the end to provide public URL “2007/toyota/camry”. The second public URL option is formulated by including all of the pairs of query parameter names and values selected in the order that they are presented in the internal URL to thereby formulate the public URL option “year/2007/make/toyota/model/camry”. The third option is formulated by selecting first the target file name (without extension), followed by all of the query parameter values of the internal URL in the order that they are presented in the internal URL to thereby formulate the public URL option “catalog/2007/toyota/camry”. The fourth option is formulated by selecting first the target file name, followed by all of the pairs of query parameter names and values m selected in the order that they are presented in the internal URL to thereby formulate the public URL option “catalog/year/2007/make/toyota/model/camry”. The list of described options is just an example. More options might be generated in other embodiments.

Referring to FIG. 2, once the various public URL options are generated, those options may also be displayed. In addition, matching rules may be automatically formulated for matching each of the public URL options corresponding to the internal URL (act 203). The options drop down list 403 may be caused to appear and disappear using the drop down control 407. The selected URL is illustrated within the option selection field 402.

A substitution URL field 404 shows the internal URL but with dereferenced locations being substituted within the URL. The substitution URL is expressed in terms of the one or more dereferences placed in the context of a schema of the internal URL. For instance, in FIG. 4, {R:1}, {R:2}, and so forth represent the location of the first, second, and so forth, value taken from the internal URL to generate the selected public URL option. The OK control 405 returns the user to the main “Edit Rule” interface 300 that will be populated in accordance to what option user has selected within user interface 400. The cancel control 406 cancels any action taken in the user interface 400, and closes the generate rule user interface 400.

At some point, the user interface receives a user selection of one of the formulated options for a corresponding public URL (act 204). There is no requirement regarding timing with respect to whether the system receives this user selection before during and/or after the matching rules are being automatically formulated (act 203). In FIG. 4, the user selection is made by selecting one of the public URL options in the options list 403, or by allowing a default public URL from the list to be selected.

FIG. 5 illustrates a user interface 500 that is similar to the user interface of FIG. 4, except that the options drop down list 403 is pulled up using drop down control 407. In addition, a full view of a rules definition region 501 is illustrated, which was previously partially obscured by the options drop down list 403 such that only the substitution URL field 404 was previously visible. The rules definition field 501 automatically displays generated matching rules for rewriting the selected public URL to the internal URL (act 205).

Specifically, a URL pattern field 502 specifies a particular pattern that is to be searched for in the internal URL. The URL pattern statement begins with an exponent marker “̂” representing the beginning of the URL pattern, and ends with a dollar symbol “$” representing the end of the URL pattern. The semantics for expressing text patterns may be standard regular expression patterns that are well known in the art and thus will only be briefly described here.

In this case, the URL pattern begins with a string of one or more text characters taken from the following character set: “_”, “−”, “+” and including any numbers and any letters of the alphabet whether lower case (a-z) or upper case (A-Z). This character set will hereinafter be referred to as the “text character set” for easier reference. The first variable length string corresponds to the position of the first dereferenced location {R:1} in the substitution URL field 404. In referencing the internal URL, it can be seen that {R:1} corresponds to the term “catalog” of the selected public URL.

The first variable length string is followed by a forward slash “/” and then followed by a series of exactly four numerical digits selected from the set 0-9. The series of four digits corresponds to the position of the second dereferenced location {R:2} in the substitution URL field 404. In referencing the selected public URL, it can be seen that {R:2} corresponds to the term “2007” of the selected public URL.

The series of four numerical digits is followed by a forward slash “/” and then followed by a second variable length string selected from the text character set. The second variable length string corresponds to the position of the third dereferenced location {R:3} in the substitution URL field 404. In referencing the selected public URL, it can be seen that {R:3} corresponds to the term “toyota” of the selected public URL.

The second variable length string is followed by a forward slash “/” and then followed by a third variable length string selected from the text character set. The third variable length string corresponds to the position of the fourth dereferenced location {R:4} in the substitution URL field 404. In referencing the selected public URL, it can be seen that {R:4} corresponds to the term “camry” of the selected public URL.

By selecting the drop down control 503 of FIG. 5, the user interface 600 of FIG. 6 may appear. The rule definition region 501′ is now modified to allow a backreference chart to be illustrated. This chart expresses the various dereferenced locations used in the selected public URL option, and the provided internal URL. For instance, the chart shows the dereference symbol in the left “backreference” column. The sample column illustrates immediately next to the symbol the sample that corresponds to that dereferenced location in both the selected public URL option and the internal URL. In the second column, if there are any characters that are to appear between the dereferenced locations in the public URL (e.g., the forward slash “/”), that symbol is illustrated as an intermediating sample in the second column. The third column indicates the matching criteria for the corresponding sample. For instance, each of the forward slashes “/” are to be an exact match to the pattern in the rightmost “pattern” column. The dereferenced location symbols {R:1} and {R:3} would be matched against any digit or character (regardless of length) as represented in the pattern column. The dereferenced symbol {R:2} would be matched against any sequence of exactly 4 digits. Scrolling down, one might also see the same information for the fourth dereferenced symbol {R:4}.

Accordingly, a mechanism is described for allowing the selection from multiple possible automatically generated public URLs corresponding to a particular internal URL. In addition, the matching rules may be inspected in detail.

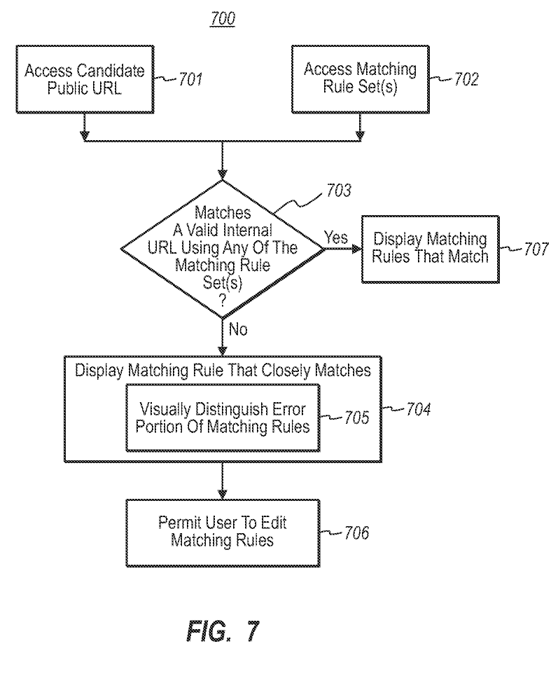

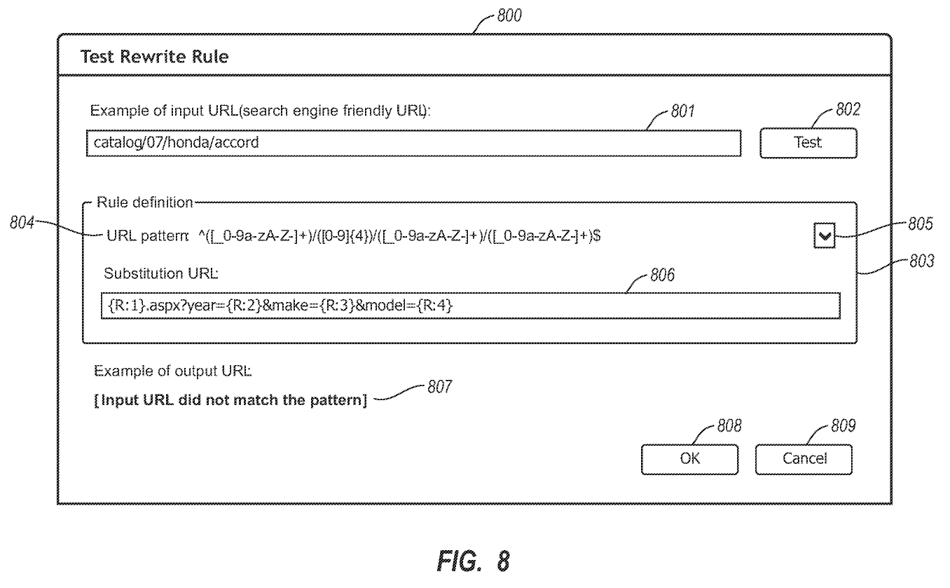

FIG. 7 illustrates a flowchart of a method 700 for testing whether a candidate public Uniform Resource Locator (URL) has a corresponding match to an internal URL. This may be accomplished using a testing user interface. One of an enumerable variety of such user interfaces is described with respect to FIGS. 8 through 10. However, this is an example user interface only. Referring to FIGS. 3 and 8, the user interface 800 of FIG. 8 might appear upon selection of the Test Rewrite Rules control 312 of FIG. 2. FIGS. 8 through 10 represent various stages of a user interface upon successive state changes.

In FIG. 7, the method 700 includes an act of accessing a candidate public URL (act 701). Referring to FIG. 8, the user might enter a candidate public URL in the input URL field 801. This user interface 800 will allow the user to test whether or not that input URL if actually used would result in a successful rewrite, and if so, what the corresponding internal URL would be. Thus, a user (or system administrator, which is a particular type of user) may determine whether or not the system is performing optimally with respect to the public URLs that the user would like to allow, and whether a proper rewrite would be made.

When the user has decided that the input URL should be tested, the user may select the test control 802. When this happens, or perhaps in advance of this happening, the computing system accesses one of more sets of matching rules (act 702). This might include a set of matching rules that were automatically generated by the method 200 of FIG. 2.

The system determines whether or not the candidate public URL matches a valid internal URL using any of the one or more sets of matching rules (decision block 703). In the first example of FIG. 8, the user interface represents a state in which there is not a match (No in decision block 703). In this case, the user interface displays one of the matching rules that most closely matches (act 704). For instance, the rules definition field 803 of FIG. 8 is very similar to the rules definition field 503 of FIG. 5. The URL pattern 804 and the substitution URL in the substitution URL field 806 may be displayed. The example of output URL 807 shows a matching internal URL if there is a match (Yes in decision block 703). However, in the case of FIG. 8 in which there is not a match (No in decision block 703), an error message is displayed such as “[Input URL did not match the pattern]”. This error message might be visually emphasized in some manner such as, for example, using red text to generate the error message. The OK control 808 and the cancel control 809 are also provided although they have not been selected yet in this user interface 800.

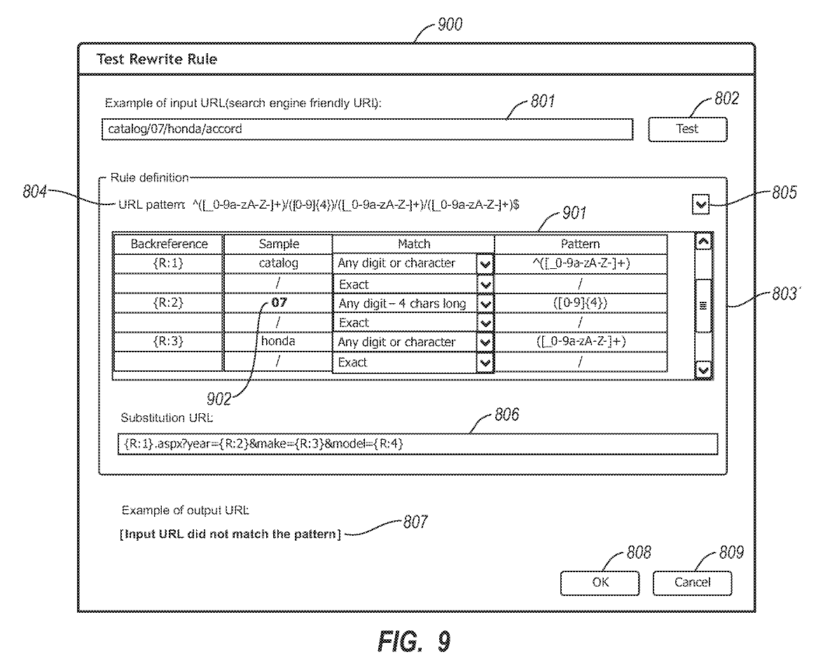

Upon selecting the drop down control 805, the user interface 900 of FIG. 9 appears. Here, the rule definition region 803′ is altered to show a backreference chart 901 once again appears. This backreference chart 901 is similar to the backreference chart of FIG. 6. However, in this case, there is not an exact match of the matching rules. Accordingly, as part of the act of displaying one of the most closely matched matching rules (act 704), the system also visually distinguishes a portion of the displayed matching rules that is causing the candidate public URL to not match the valid internal URL using the displayed matching rules (act 705). In this example, there is only a two digit number 07 following the text “catalog/” in the input URL. However, the matching rules specify that there should be a four digit number there in order for the matching rules to rewrite to an internal URL. Accordingly, the sample “07” illustrated at location 902 may be highlighted, or in red text, or have some other visually distinguishing feature that cues the user that this is the point of error in the input URL.

The user interface 900 may permits a user to edit the matching rules (act 706) to thereby correct the error. For instance, the user might change the text ([0-9]{4}) to read instead ([0-9]{2,4}) to allow either a sequence of either two or four sequences at the second dereferenced location {R:2}. This edit might be made directly into the corresponding row of the pattern column in the backreference chart 901.

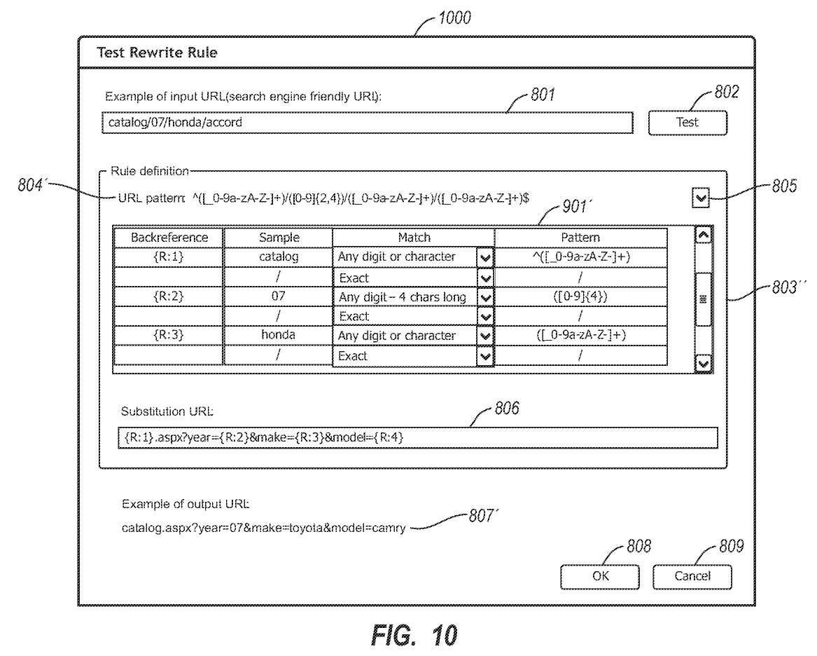

FIG. 10 illustrates a resulting user interface 1000 showing that the rule definition region 803″ is further modified to include the slightly modified backreference chart 901′ and showing the slightly altered URL pattern 804′. Here, there now exists matching rules that directly match the input URL to correlate to a matching internal URL (Yes in decision block 703) due to the slight modifications in the matching rules. Accordingly, the user interface displays the matching rules that match (act 707) in addition to displaying the exact corresponding internal URL 807′.

Therefore, an effective mechanism is described for generating and testing public URLs corresponding to an internal URL. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-assisted method for generating matching rules for a proposed public Uniform Resource Locator (URL) to a corresponding user-selected proposed internal URL, the method comprising:
an act of accessing the user-selected proposed internal URL; and
an act of automatically generating a plurality of options for a public URL corresponding to the internal URL.

2. A computer-assisted method in accordance with claim 1, further comprising:
an act of receiving a user selection of one of the plurality of options for the public URL corresponding to the internal URL; and
an act of displaying a rule generation user interface whereby a user might view automatically generated matching rules for matching the selected public URL to the internal URL.

3. A computer assisted method in accordance with claim 2, further comprising:
an act of accessing a candidate public URL using a testing user interface;
an act of accessing one of more sets of matching rules including the automatically generated matching rules;
an act of determining that although the candidate public URL does not match a valid internal URL, the automatically generated matching rules are a close match; and
an act of displaying automatically generated matching rules is response to the act of determining.

4. A computer-assisted method in accordance with claim 3, further comprising:
an act of visually distinguishing a portion of the automatically generated matching rules that is causing the candidate public proposed internal URL to not match the valid internal URL using the displayed matching rules.

5. A computer-assisted method in accordance with claim 4, further comprising:
an act of providing a user interface that permits a user to edit the matching rules.

6. A computer-assisted method in accordance with claim 2, wherein the rule generation use interface may also be used by the user to enter the user-selected proposed internal URL, and to select the selected public URL.

7. A computer-assisted method in accordance with claim 2, wherein the rule generation user interface also provides a mechanism for selecting an action to take when matching the selected public URL to the internal URL.

8. A computer-assisted method in accordance with claim 7, wherein one of the options is to rewrite the selected public URL into the internal URL in preparation for further processing of a request that was associated with the selected public URL.

9. A computer-assisted method in accordance with claim 2, wherein the matching rules are expressed by formulating one or more dereferences corresponding to the selected public URL, acceptable patterns for each of the one or more dereferences.

10. A computer-assisted method in accordance with claim 9, wherein the matching rules further include a substitution URL expressed in terms of the one or more dereferences placed in the context of a schema of the internal URL.

11. A computer-assisted method in accordance with claim 1, further comprising:
an act of automatically formulating matching rules for matching each of the plurality of options for a public URL corresponding to the internal URL.

12. A computer program product comprising one or more computer-readable media having thereon computer-executable instructions that, when executed by one or more processors of a computing system, cause the computing system perform a method of testing whether a candidate public Uniform Resource Locator (URL) has a corresponding match to an internal URL, the method comprising:
an act of accessing a candidate public URL;
an act of accessing one of more sets of matching rules;
an act of determining whether or not the candidate public URL matches a valid internal URL using any of the one or more sets of matching rules; and
if it is determined that there is not a match, an act of displaying one of the matching rules that most closely matches.

13. A computer program product in accordance with claim 12, wherein the one or more computer-readable media are physical memory and/or storage media.

14. A computer program product in accordance with claim 13, wherein the act of displaying one of the matching rules that most closely matches comprises:
an act of visually distinguishing a portion of the displayed matching rules that is causing the candidate public URL to not match the valid internal URL using the displayed matching rules.

15. A computer program product in accordance with claim 14, the method further comprising:
an act of providing a testing user interface that permits a user to edit the matching rules.

16. A computer program product in accordance with claim 15, wherein the testing user interface is also used to receive the candidate public URL, and to display one of the matching rules that most closely matches if it is determined that there is not a match.

17. A computer program product in accordance with claim 13, the method further comprising:
if it is determined that there is a match, an act of displaying the matching rules that match.

18. A computer program product comprising one or more computer-readable media having thereon computer-executable instructions that, when executed by one or more processors of a computing system, cause the computing system perform a method for generating matching rules for a proposed public Uniform Resource Locator (URL) to a corresponding user-selected proposed internal URL, and then testing whether a candidate public Uniform Resource Locator (URL) has a corresponding match to an internal URL using the generated matching rules, the method comprising:
an act of accessing the user-selected proposed internal URL; and
an act of automatically generating a plurality of options for a public URL corresponding to the internal URL;
an act of receiving a user selection of one of the plurality of options for the public URL corresponding to the internal URL;
an act of displaying a rule generation user interface whereby a user might view automatically generated matching rules for matching the selected public URL to the internal URL;
an act of accessing a candidate public URL;
an act of accessing one of more sets of matching rules including the automatically generated matching rules;
an act of determining whether or not the candidate public URL matches a valid internal URL using any of the one or more sets of matching rules; and
if it is determined that there is not a match, an act of displaying one of the m matching rules that most closely matches.

19. A computer program product in accordance with claim 18, wherein the one or more computer-readable media are physical memory and/or storage media.

20. A computer program product in accordance with claim 19, further comprising:
an act of visually distinguishing a portion of the displayed matching rules that is causing the candidate public URL to not match the valid internal URL using the displayed matching rules.
